(19) United States
(12) Patent Application Publication
(10) Pub. No.: US 2021/0129369 A1
(43) Pub. Date: May 6, 2021

(54) A Hinged Ingredient Slicing Apparatus

(71) Applicant: Kevin James Saccone, JR., Norwood, MA (US)

(72) Inventor: Kevin James Saccone, JR., Norwood, MA (US)

(21) Appl. No.: 16/674,874

(22) Filed: Nov. 5, 2019

(51) Int. Cl. B26D 7/06; B26D 1/02

(52) U.S. Cl. CPC B26D 7/0641; B26D 5/00; B26D 2210/02; B26D 1/02

(57) ABSTRACT

The present invention relates to the field of automated food preparation. Specifically, the present is a system and method for depositing slices of an ingredient onto a bread or other media. Additionally, the present invention can be used to selectively slice a plurality of ingredients onto a sandwich based on customer inputs and the apparatus can be used for slicing meats, cheeses, vegetables and other deli products.

### BACKGROUND OF THE INVENTION

### Field of the Invention

The present invention relates generally to food preparation. More particularly the present invention relates to a system and method that may automatically make a plurality of different food items with different ingredients wherein the ingredients are deposited by a machine (the apparatus) which is governed by a computer. The apparatus outlined herein is most useful in regard to the making of fast food items such as sandwiches, salads, pizzas and etc. or in simply slicing ingredients such as cold-cuts to order as is done in supermarkets across the United States.

### BACKGROUND

The conventional fast-food production process involves human labor “prepping” the ingredients each day by means of slicing, chopping, portioning and etc. a multitude of ingredients based on a rough estimate of daily demand; and then storing the prepared ingredients in a refrigerated preparation table; then when a customer orders a certain menu item an employee generally removes the prepared ingredients from the preparation table and then assembles the order by hand. To clarify for those unfamiliar with the standard practices in the food industry; suppose a restaurant sells sandwiches and salads, the workers will generally prep the ingredients such as cold-cuts, vegetables, condiments and etc. and ensure that a sufficient quantity of each is ready to meet customer demands in a timely manner and load the ingredients in a refrigerated prep table which holds the ingredients at a height that is convenient for the workers to access and visualize at a given moment.

Then, as each order comes in, a worker must read a ticket or display and then take pre-prepared foods from the prep table and assemble the order by hand matching the customer's order on the ticket or display. For instance, if someone orders a ham and cheese with lettuce tomato and mayo, the worker will get a printed ticket outlining the requested order, they must then read the ticket, then scan the prep table to locate the lettuce, tomato, ham and cheese and then place each ingredient onto the sandwich bread in a process that has a great deal of wasted motion and also a high potential for inaccurate order fulfillment and portion controls.

Therefore, what is presented herein is a food preparation system which eliminates the wasted motions involved in the process of preparing and storing ingredients in a refrigerated prep table, and then slowly and inaccurately assembling the ingredients by hand per each order, and also eliminates the waste and defect opportunities involved in printing receipts to be read by workers. Instead, the present invention will host all the ingredients of a specified menu within an apparatus or group of apparatuses that are contained within a refrigerated unit or room, and slice each ingredient as it is needed with the agility and ability to selectively deposit and control each ingredient that gets deposited onto the bread or another medium in order to complete a sandwich or other food item that is made to order and do so in a fast and automated fashion wherein the apparatus can communicate directly with a point of sale system, customer kiosk, mobile device or etc. reducing the amount of defect opportunities and “middle men” involved in the production of a food item.

### SUMMARY OF THE INVENTION

Be it known that I, Kevin J. Saccone Jr., of Norwood, Mass. have invented certain improvements for depositing ingredients onto a food item, of which the following is a full, clear and exact description which outlines the scope and nature of the present invention.

The primary aspect of the food preparation system outlined herein is a slicing apparatus which slices ingredients as the method of depositing them onto a piece of bread or other medium. The present invention houses multiple ingredients simultaneously in separate chambers within a chassis and passes the separate chambers over a blade by rotating the chassis while maintaining control over which ingredients are to be sliced. This apparatus has the capability of taking computer inputs and directing the apparatus to slice particular ingredients without any changeover time to load and unload different ingredients. The slicing apparatus can slice directly onto a sandwich, deli bag, or other medium traveling beneath the apparatus on a conveyor.

The present invention enables one to create an automated food preparation system. The food preparation system outlined in this invention uses a computerized system including: a computer memory, processor, inputs and outputs, a display, sensors and all hardware and software components necessary to run a state-of-the-art industrial machine and to integrate the present invention with other computerized devices, and to send commands to control and operate machinery designed to deposit ingredients. These ingredients may be deposited onto a form of bread, dough, a salad bowl, or straight into a package or bag.

For example, as the bread moves along a conveyor, the apparatus would deposit ingredients onto the bread from above, by means of slicing a pre-determined portion of each ingredient onto the bread as it passes below the apparatus on a moving conveyor, and it would receive the instructions/inputs on which particular ingredients to deposit from a customer or food service worker or automated process.

The present invention is designed to build sandwiches and similar food items to order based on a customer's requests. The present invention is unique in the sense that it can quickly and efficiently create food items via machinery while remaining agile enough to tailor each order according to the customer's requests. This is greatly different from some factory style, low variety, high production, sandwich assembly lines where the food items are produced in bulk and without variation and they are generally distributed as pre-made sandwiches; and switching from producing one food item to another often has notable changeover and production costs.

The apparatus outlined herein is so agile that it can be utilized in the retail environment and make food items to order as part of a just-in-time production system which fulfills an order rapidly based on a customer's specific requests. This can be accomplished in several ways. One of which involves the customer placing their order at the point of sale by means of either operating a self-serve kiosk, ordering on their mobile device or computer, or verbally instructing a food service worker who is operating a computerized device integrated with the slicing apparatus, the apparatus can then gather all the inputs necessary to complete one sandwich or other food item, and then command the slicing apparatus(es) to build the sandwich as instructed by the customer.

In another configuration, the computerized system may receive inputs throughout the process of forming the food item. For example, inputs may be provided incrementally as customers move alongside their food item in a waiting line that runs parallel to the assembly line and choose which ingredients they want dispersed onto their food item as they watch it being made. This embodiment may require an integrated touch screen or substitutable input device that gives customers or employees the ability to choose which ingredients to dispense onto their food item from the machinery.

The input device can show the available options at each station and give customers the ability to choose which ingredients they want on their food item. The input may then be received by the computerized system, and generate a command sent to the equipment to instruct it to disperse the selected ingredients onto their food item. For instance suppose a menu required a total of three slicing apparatuses to be used, one for produce, one for meats and one for cheese in that respective order the customer could start at the slicing apparatus for produce, look at the list of options and then select which options they want on their sandwich, shortly after the selection is made the slicing apparatus would deposit the selected ingredients onto their bread, then the bread would move down a conveyor belt so that it is positioned under the meat slicing apparatus wherein they would again select which meats to deposit onto their sandwich and the process would continue as the customer follows their food item along and presumably watches their food item being made via a glass safety window and provides inputs by means of a touch screen or similar device on their side of the safety glass. Although such customer participation will not be necessary in all applications of the invention, it may provide an interactive experience for customers which may be valuable to distract and engage customers while they are waiting for their food.

Such a flexible, yet mechanized, manufacturing solution is currently not found in the food service industry where businesses typically rely on agile and adaptable human labor to deal with a high volume of special requests, variations and substitutions in orders. The present invention will help restaurants and food service businesses increase the productivity of human labor, and decrease the costs associated with human error such as inaccurate order fulfillment and portion controls by assembling food products such as sandwiches, wraps, burritos, and salads primarily by machine.

Such savings for restaurants will also be advantageous to the consumers and employees as restaurants can offer more competitive pricing and higher quality ingredients meanwhile enabling higher wages to be paid as the machinery increases the production capacity and earning potential of employees working in food service establishments. It is important to note that the final configuration of each slicing apparatus will be dependent upon the menu or application it is being used for but the principles of operation will remain the same and are outlined herein.

The following drawings will demonstrate how the slicing apparatus operates and the novel characteristics of the method and apparatus.

### BRIEF DESCRIPTION OF THE DRAWINGS

FIG. 1 shows a perspective view of the slicing apparatus, wherein the motion of the chassis is paused and one ingredient chamber is removed from the chassis.

FIG. 2 is a perspective view depicting the engagement bumper in the non-slicing position.

FIG. 3 is a perspective view depicting the engagement bumper in a slicing position.

FIG. 4 is a perspective view depicting an ingredient tube being moved on its hinged axis as the chassis rotates counter clockwise and the engagement bumper is in the slicing position.

FIG. 5 is a perspective view depicting an ingredient moving over the blade.

FIG. 6 is a perspective view depicting the contents of an ingredient tube being sliced by the blade.

FIG. 7 is a perspective view that shows the contents of an ingredient tube not being sliced by the blade.

FIG. 8 is a perspective view of the ingredient glide platforms and the blade.

FIG. 9 is a perspective view of an open and empty ingredient tube removed from the apparatus.

FIG. 10 is a top view of an ingredient tube positioned above the ingredient stop.

FIG. 11 is a top view of an ingredient tube in the slicing position.

FIG. 12 is a side view of an automated assembly line using three slicing apparatuses to build sandwiches.

### DETAILED DESCRIPTION

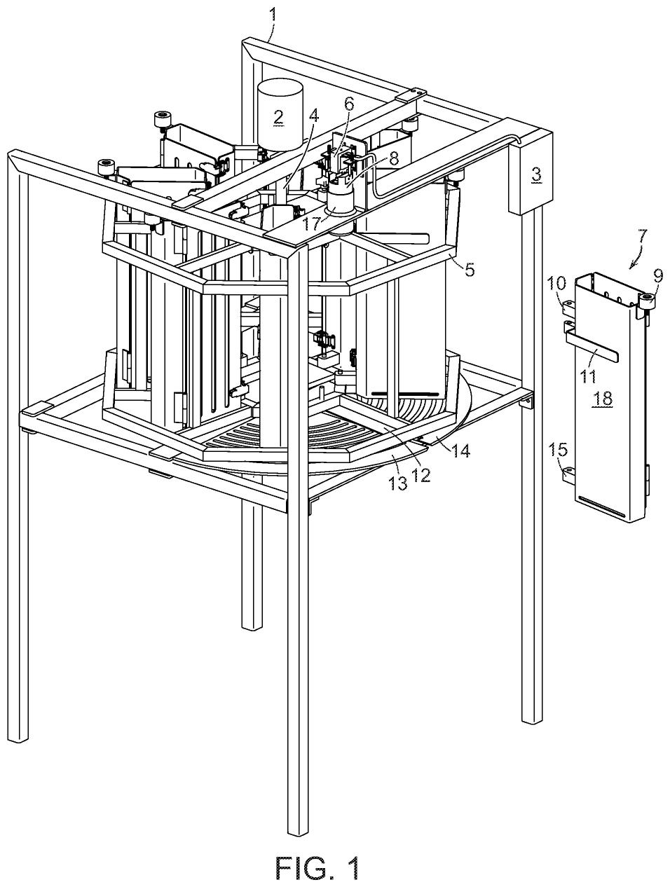

FIG. 1, the apparatus comprises of a frame [1], which provides support for the motor [2], controller [3], driveshaft [4], chassis [5], actuator [6], lower ingredient glide [13] and higher ingredient glide [14]. The chassis [5], as depicted, holds eight ingredient tubes [18]. One separate ingredient tube [7] has been removed from the chassis [5] in this figure. The tubes [18] are mounted to the chassis [5] via an upper hinge mount [10] and lower hinge mount [15] which get seated the protruding pins of the chassis [5] and enable the tubes [18] to rotate on a hinge within a section of the chassis [5]. The tubes [18] are held to the rightmost position of each section of the chassis by spring bar [11], which holds the tube over ingredient stopper [12].

The motor [2] rotates the driveshaft [4] in a counter-clockwise rotation and the chassis [5] is keyed to the driveshaft [4] so the two move in unison. The motor [2] has a built-in encoder which can provide a real time reading of the position of the driveshaft [4] from 0-360 degrees or in finer increments and communicate the position to the computer [3]. The computer also controls the position of the engagement bumper [8] by controlling the actuator [6] which is depicted as an electrical solenoid but a plurality of actuators are feasible within the scope of the invention such as an air cylinder, hydraulic cylinder, electric motor or etc. The apparatus works by rotating the driveshaft [4] and chassis [5] counter clockwise and by moving the engagement bumper [8] up and down vertically while the chassis [5] is in a state of rotation.

In instances where the engagement bumper [8] is lowered it will make contact with the ingredient tube bumper [9], causing the tube [18] to rotate to the left, moving the tube off of stopper [12] so that the ingredients within the tube can travel downwards onto the lower blade platform [13]. Next, an ingredient can come into contact with the blade [19]. As the chassis [5] continues its course of counterclockwise motion, the tube [18] which travels all the way to the leftmost sectional of the chassis [5] where its motion is stopped by making contact with the divider that is part of chassis [5], bumper [9] slips off of engagement bumper [8] as the two are made of low friction materials, allowing the tube [18] to travel back to the rightmost position, where it will be positioned on top of stopper [12], the left to right motion is caused by spring bar [11] which uses a torsion spring to return the tube [18] above the stopper [12] to make contact with the right side divider of chassis [5], when bumper [9] is not being contacted by engagement bumper [8].

The engagement bumper [8] is scientifically positioned in a location that allows the tube bumper [9] to slip off when it is nearing the left most divider of the chassis [5] and furthermore, this action is to occur over the lower platform [13] so that when the ingredient is moved off the stopper [12] by the engagement bumper [8] the ingredient can be brought into contact with the blade [19] prior to returning to the position above the stopper [12].

Note that when the tube [18] is in the rightmost position within a divided sectional of the chassis [5] the bumper [9] is a short distance away from the outer edge of the chassis [5]. However, as the tube is moved leftward within the divided sectional of the chassis [5] the distance between the edge of the chassis [5] and the bumper [9] increases due to the nature of the hinged movement. This is significant because as the engagement bumper [8] when extended is in close proximity to the outer edge of the chassis [5] where the engagement bumper will contact bumper [9], as the tube [18] pivots due to bumper [9] contacting engagement bumper [8] while the chassis [5] is rotated, bumper [9] gradually slips out of contact with bumper [8] as the distance between the two bumpers is separated by the hinged movement.

A simple visual analogy to envision this movement is to picture the front view of a push style door with the knob on the left and the hinges on the right. When the door is in the closed position the leftmost edge of the door is contacting the door frame, however, as the door is pushed open, the distance between the door frame and the leftmost edge of the door begins to get wider, because of the hinged movement. Relating the doorway analogy to the slicing apparatus, when the ingredient tube [18] is in the rightmost position above stopper [12] it is akin to the door being closed and ingredient bumper [9] is closest to the outer edge of the chassis where it will make contact with engagement bumper [8]. As ingredient tube [18] pivots from right to left ingredient bumper [9] gradually slips out of contact with engagement bumper [8].

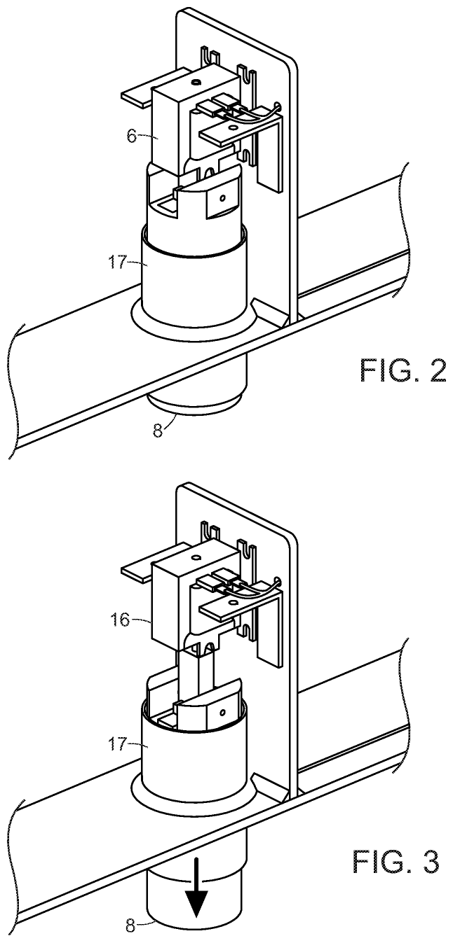

FIG. 2 shows the engagement bumper [8] in the retracted or non-slicing position. The engagement bumper [8] is secured in a tubular housing [17] and the engagement bumper [8] has a vertical keyway cut into it which mates with a square key inside of housing [17] to prevent engagement bumper [8] from rotating, while still allowing vertical movement up and down as actuator [6] extends and retracts. Actuator [6] is depicted as an electrical solenoid although a plurality of movement generating devices could be used within the scope of the present invention, actuator [6] is connected to bumper [8] via a rod. In the retracted or non-slicing position, ingredient tube bumper [9] will simply pass by underneath the engagement bumper [8] without making any contact.

FIG. 3 shows the engagement bumper [8] in the extended or slicing position. An arrow depicts that the bumper [8] has been pushed vertically downwards by the fully extended actuator [16]. In this position the engagement bumper [8] will intercept the path of ingredient bumper [9] as the chassis [5] is rotated causing the ingredient tube [18] to pivot from right to left within a section of the chassis [5] until bumper [9] slips off engagement bumper [8]. Since the chassis is rotating in a counter-clockwise direction, bumper [9] will make initial contact with the left side of engagement bumper [8].

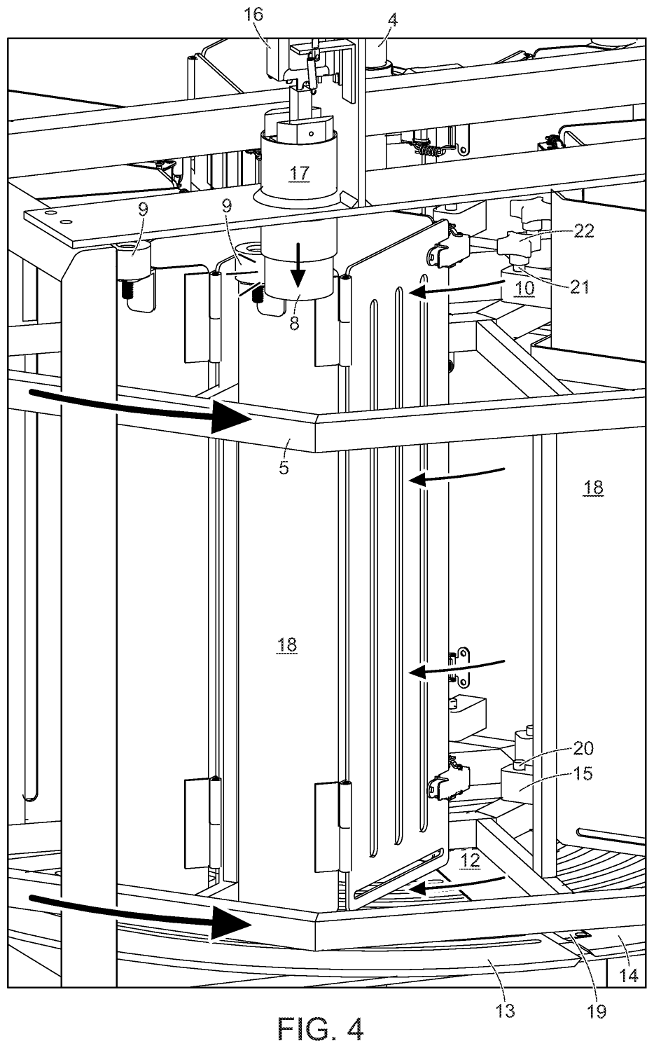

FIG. 4 shows an ingredient tube [18] moved to the leftmost position within its range of motion within the divided section of chassis [5]. We can see that the ingredient tube [18] is no longer over stopper [12] which is a part of the chassis [5] and therefore the ingredients within the ingredient tube [18] could move downwards and make contact with the lower glide [13] because the ingredients are no longer resting upon the stopper [12] in this leftmost position. Left to right facing arrows depict the counter-clockwise rotation of the chassis [5], which moves in unison with driveshaft [4]. Meanwhile, right to left facing arrows depict the right to left movement of the ingredient tube [18] that occurred as the ingredient tube bumper [9] makes contact with engagement bumper [8].

The right to left motion of the ingredient tube is relative to the position of the chassis [5] because the ingredient tube is simply interrupted from moving in unison with the chassis [5] and driveshaft [4] due to the contact of engagement bumper [8] and ingredient bumper [9], so in essence the ingredient tube [18] is being held still while the chassis [5] is rotated, and the stillness is engineered to last until the ingredient tube [18] reaches the leftmost section of the chassis [5] and this point coincides with when bumper [9] slips off of engagement bumper [8] due to the change in relative distance as the ingredient tube [18] moves on its hinge.

The hinge mechanism can be more clearly seen from this view as upper pin [21] which is an extension of chassis [5] is mated with upper hinge mount [10]. Upper pin [21] has a threaded top to accommodate knob [22] which fastens the ingredient tube [18] to the chassis [5] while allowing them to pivot on hinge. Likewise, lower hinge pin [20] is mated with lower hinge mount [15] to provide a more stable pivot point. It is also important to understand that stopper [12] is part of chassis [5] and remains fixed to the rightmost section within each division of the chassis [5]. Stopper [12] has a filleted edge on the left side to enable smooth transitions as ingredients move off of stopper [12] and back onto stopper [12]. When an ingredient is not being sliced, the ingredient tube [18] is positioned above stopper [12] and the ingredients themselves are making contact with stopper [12] preventing them from falling out of the apparatus and minimizing friction.

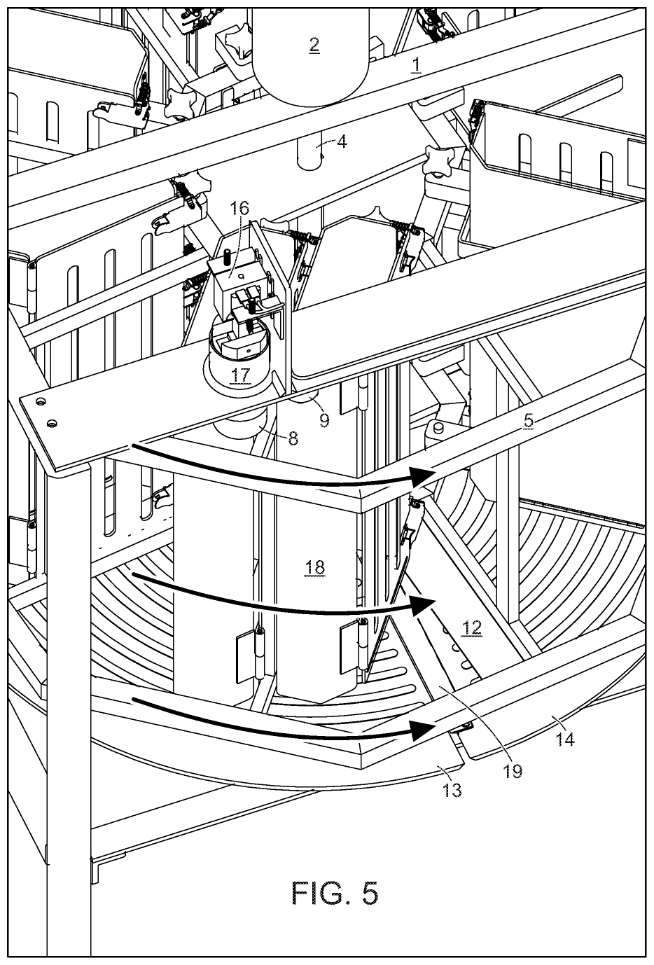

FIG. 5 depicts ingredient tube [18] passing over the blade [19]. The blade [19] depicted herein is a simple knife style blade secured to higher ingredient glide [14] but a plurality of blade styles are feasible and within the scope of the present invention. The blade style would be determined by the menu and ingredient selections that are to be hosted in a particular apparatus. For instance, a powered rotary blade, reciprocating blade, banded blade, wire, or etc. could be used to perform the cutting function, and furthermore the power to move the blade could be transferred from the motor [2] which drives the driveshaft [4] by means of belts, gears and power transmission devices.

Note that in this position, bumper [9] is no longer contacting engagement bumper [8] as it has slipped off. Also, note that there is a gap between glide [13] and glide [14], the gap is due to the fact that the glide [13] is vertically lower, relative to glide [14] this is necessary so that the edge of the blade [19] makes contact with a food ingredient that is presumably in contact with blade glide [13].

Since bumper [9] is no longer in contact with engagement bumper [8] the spring bar [11] begins moving the ingredient tube [18] back to the rightmost position above stopper [12] but the return to the right is not instantaneous due to the forces generated by the rotation of the chassis [5], therefore the ingredient tube [18] occupies the leftmost position within the sectional of chassis [5] just long enough to allow the ingredient within ingredient tube [18] to pass over the blade [19] and the ingredient tube [18] return to the rightmost position above stopper [12] as the chassis rotates the ingredient tube [18] over glide [14].

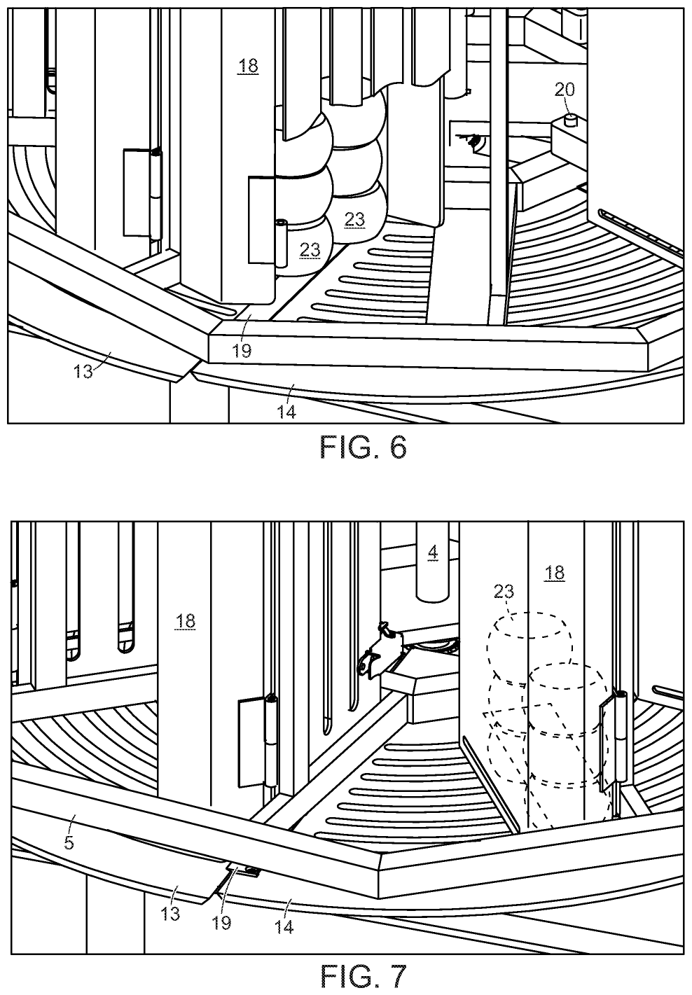

FIG. 6 shows an example of how multiple stacks of ingredient can be hosted in one ingredient tube [18]. A portion of ingredient tube [18] has been made transparent to depicts the contents of tube [18]. Two columns of prepared tomatoes [23] are stacked vertically in ingredient tube [18] and when the tomatoes [23] make contact with blade [19] two slices will be generated. By hosting multiple columns of ingredients within a single tube [18], multiple slices can be generated each time an ingredient tube [18] passes over the blade.

Therefore, if one were utilizing the present invention to assemble a sandwich recipe which called for two sliced of tomatoes, it would only require a single movement of engagement bumper [8] and ingredient tube [18] to generate the two slices. Furthermore, the ingredient tubes [18] depicted herein are shown as homogenous and generic ingredient tubes however, with certain situations custom shaped ingredient tubes would be the preferred embodiment. Likewise, interior lips, channels and tubes within an ingredient tube [18] are well within the scope of the invention and would be very helpful in supporting ingredients which do not stack easily.

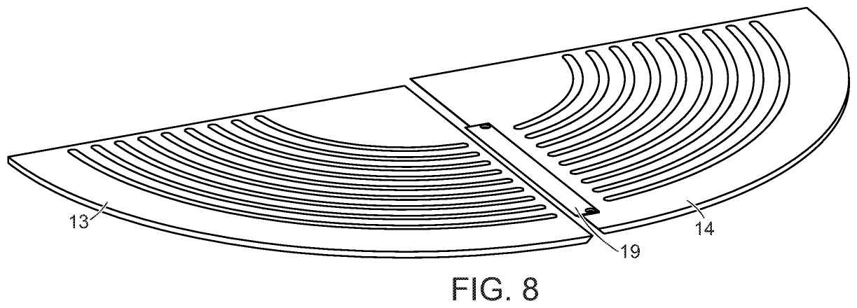

FIG. 7 shows the ingredient tube [18] positioned to in the rightmost section of the chassis [5]. The tube [18] moves back to this position via the force of the spring bar [11] while the tube [1]8] is rotated over the higher glide [14] after an ingredient has been sliced by blade [19].

FIG. 8 is a simple depiction of the lower ingredient glide [13], the higher ingredient glide [14] and the blade [19] to show the components without any other parts blocking their visibility. The top face of blade [19] is flush with the glide [14] and is secured to glide [14] by screw style fasteners. There is a recession milled out underneath blade [19] approximately equal to the thickness of blade [19] which allows the top of the blade to be flush with glide [14]. Also, there is a beveled edge of glide [14] along the same edge that blade [19] occupies to open up space for ingredient slices to pass through.

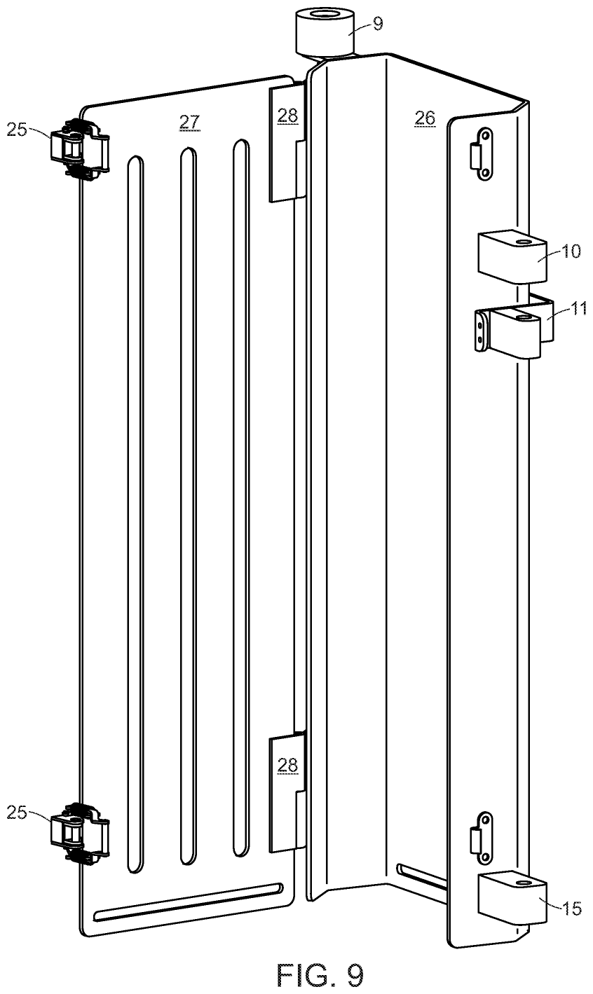

FIG. 9 depicts an ingredient tube [18] that has been removed from the apparatus and shows its constituent parts, the ingredient tube rear [26] is connected to the ingredient tube front [27] by the lift off hinges [28]. The front [27] moves on the hinges [28] and is secured shut by draw latches [25] once it is filled with ingredient. Ingredient bumper [9] is mounted to a 90-degree bracket which is welded or fastened to the outer edge of the rear [26].

Note that there is a slot cut out of the front [27] and the rear [26], the slot is used to hold an ingredient bottom that serves the purpose of keeping ingredients within the ingredient tube [18] when transporting the tube [18] from the kitchen to the chassis [5], once the ingredient tube is secured to chassis [5] the bottom can be pulled out of the slot by hand and removed before operating the apparatus. Once secured to the chassis [5] and the ingredient bottom is removed the ingredients will fall down and rest on stopper [12]. The shape or design of the ingredient tube [18] is not paramount to the present invention as a plurality of options would work, the preferred embodiment uses an ingredient tube [18] that can be opened and removed for easy loading, unloading and cleaning.

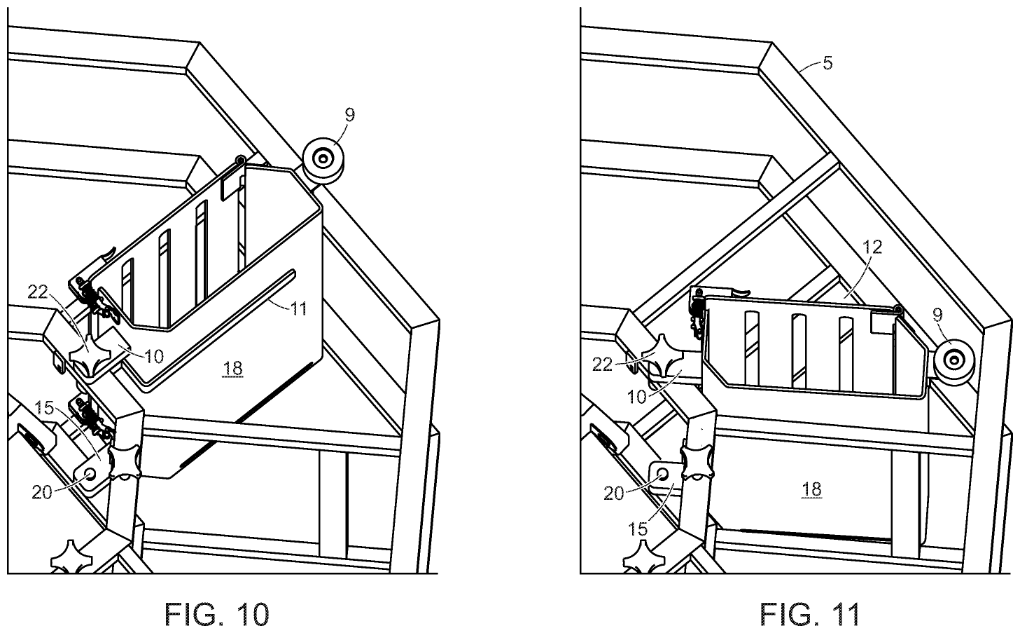

FIG. 10 further depicts the ingredient tube [18] in the “rightmost” position of the chassis [5] where it is positioned on top of stopper [12]. Note that the chassis [5] has been divided into eight sections in the demonstrated embodiment of the present invention and each section is separated by a bar which connects the inner and outer octagons of chassis [5], and in both the rightmost and leftmost position of the chassis [5] the ingredient tube is making contact with one of these bars which doubles as a stop and restricts the hinged movement of the ingredient tube [18] to the range of motion between the bars.

Also note that in the rightmost position, the ingredient bumper [9] is positioned over the outer edge of the chassis [5] this is the position where it will make initial contact with engagement bumper [8].

FIG. 11 further depicts the ingredient tube [18] in the “leftmost” position where the tube [18] has moved off of stopper [12]. Note that in this position the ingredient bumper [9] is positioned inside the outer edge of the chassis [5] and in this position it would slip off of engagement bumper [8] which is positioned with its circumferential edge aligned roughly tangent to the outer edge of chassis [5] with the body of engagement bumper positioned primarily outside of chassis [5] when viewed from above.

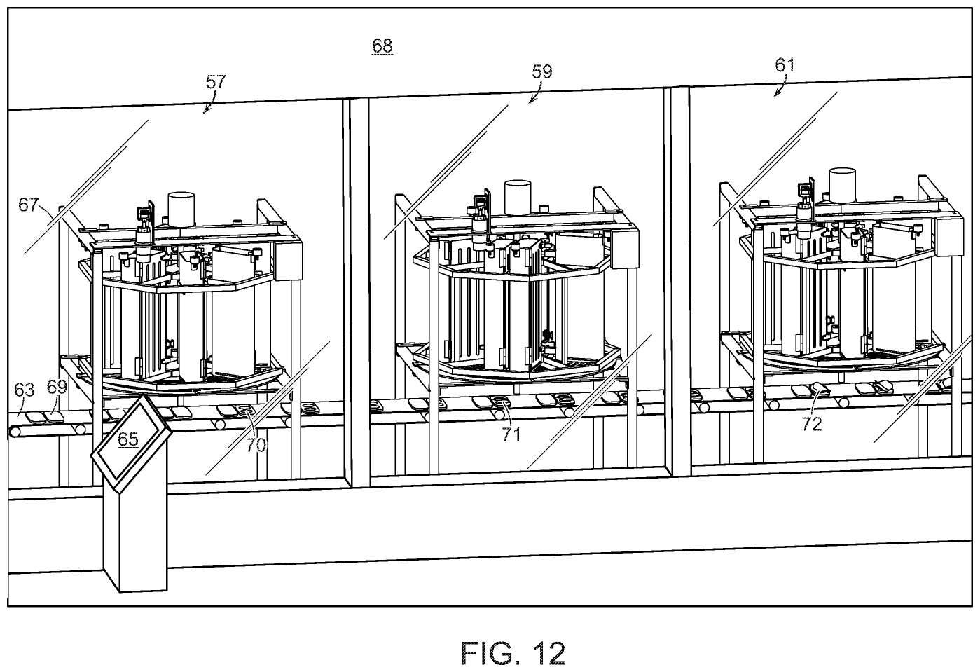

FIG. 12 shows three slicing apparatuses being used to deposit ingredients onto a motorized conveyor [63]. From left to right we have a slicing apparatus stocked with vegetables [57] a slicing apparatus stocked with cheese [59] and slicing apparatus stocked with meats [61]. Bread with no ingredients on it [69] is positioned at the start of conveyor [63], the conveyor as depicted would move the bread [69] from left to right passing under all the machines to have slices deposited onto it. Bread with vegetables deposited onto it [70] is shown, slightly to the right of vegetable apparatus [57] presumably the vegetables from apparatus [57] have been sliced and deposited onto bread [70]. Bread with vegetables and cheese deposited onto it [71] has presumably passed underneath vegetable slicer [57] and cheese slicer [59] receiving a combination of both vegetable and cheese ingredients sliced onto the bread [71].

Bread with vegetables, meat, and cheese deposited onto it [72] is seen towards the right end of the conveyor [63]. This bread [72] has presumably passed underneath vegetable slicer [57], cheese slicer [59] and meat slicer [61] and received a combination of vegetables, meat and cheese deposited onto the bread [61] in that order. Note that unlike materials such as vegetables, meat and cheese could all be stored within a single slicing apparatus. However, the preferred embodiment elects to use a plurality of slicing apparatuses to minimize cross contamination and due to the simple fact that different ingredient categories are typically sliced with a different style blade and at different thicknesses for optimal cutting performance.

A computerized kiosk [65] is shown outside on the other side of the glass windows [67] and insulated paneling [68]. The paneling [68] and windows [67] enclose the slicing apparatuses in a refrigerated room that would keep the temperatures between 33-40 degrees Fahrenheit for most applications and likewise control the humidity to optimize the shelf life of the food ingredients.

The kiosk [65] is in communication with: the conveyor [63], vegetable slicer [57], cheese slicer [59], meat slicer [61] and also with a plurality of sensors that can detect the presence of bread along the conveyor [63]. Therefore, a customer or employee could choose their selected ingredients from kiosk [65] to build a sandwich and then the kiosk [65] would send the necessary outputs to the slicing apparatuses to ensure that veggie slicer [57] deposits the selected vegetable ingredients onto the sandwich based on the customer inputs, cheese slicer [59] deposits the cheeses selected cheeses onto the sandwich and meat slicer [61] deposits the selected meat ingredients onto the sandwich.

The custom sandwich being built by inputs from kiosk [65] would begin as plain bread [69] and would be built into a sandwich based on the selections made at the kiosk [65]. The actual method of depositing the ingredients for each of the three slicing apparatuses in this figure is the same and it involves the apparatus computer [3] receiving inputs from the kiosk [65] commanding which ingredients are to be deposited onto the next bread that travels underneath the apparatus. A bread sensor, not shown herein is a simple photoelectric sensor along the conveyor [63] with at least one bread sensor being positioned underneath each of the slicing apparatuses. When a bread sensor detects that a bread is in the correct position along conveyor [63] to begin receiving slices, computer [3] sends commands to actuator [6] to extend the engagement bumper [8] at the correct times that it makes contact with the correct ingredient bumper [9] and slices the selected ingredients onto the bread as it moves along the conveyor [63].

In summary, a sandwich order is selected on the kiosk with a combination of different vegetables, meats, and cheeses, the kiosk then communicates with the vegetable slicer [57] to put the chosen vegetable ingredients onto the sandwich, next the cheese slicer [59] deposits the cheeses selected at the kiosk, and finally the meat slicer [61] deposits the meats selected at the kiosk to compile a completed sandwich matching the ingredients chosen at the kiosk. In the preferred embodiment the chassis [5] in each of the vegetable slicer [57], cheese slicer [59] and meat slicer [61] would be spinning in a counter clockwise rotation at a constant speed and the position of the engagement bumper [8], which is controlled by the computer [3] in communication with actuator [6], dictates whether an ingredient is sliced or not.

It is important to understand that a kiosk [65] is one of many methods of sending inputs to the slicing apparatuses as the apparatuses could be outfitted to create sandwiches based on orders received online, via mobile devices and etc. Furthermore, let it be understood that the kiosk [65] is a fully equipped industrial computer that is in communication with all of the slicing apparatuses and components of the assembly line and can run a variety of applications simultaneously. Furthermore, one of the slicing apparatus computers [3] or the computer of the kiosk [65] would also be running an application to track and index bread on the conveyor to a particular customer's order or inputs by using the bread sensors with a software application that uses counters and etc.

For instance order number 90 is next in the queue, computer [3] fetches the ingredients for order number 90 from an array or digital packet and then deposits those ingredients when bread sensor detects bread for order number 90, each time bread sensor detects bread it can add one to order queue so now computer [3] fetches data for order number 91 and etc. The kiosk [65] has the means to build a queue in the event that orders are received faster than the output of the machinery and to keep track of which ingredients are to be deposited onto each bread.

I claim:

1. A food slicing apparatus comprising:
a plurality of ingredient chambers used for holding a plurality of food ingredients within the apparatus simultaneously,
a blade;
a chassis, used to host the ingredient chambers adjacent to the blade, the chassis being rotatable upon an axis, the ingredient chambers being secured to the chassis in a manner than enables each chamber to move within the chassis on a hinged axis.

2. The food slicing apparatus of claim 1 wherein the position of the ingredient chamber as it moves along the hinged axis determines whether the ingredients within the chamber will be allowed to move vertically downward.

3. The food slicing apparatus of claim 3 wherein the food ingredients will make contact with the blade if they are allowed to travel vertically downward.

4. A method for selectively slicing a plurality of food ingredients comprising:
hosting a plurality of food ingredients in individual chambers secured to a rotatable chassis, wherein each ingredient chamber is moveable on a hinged axis within the chassis,
rotating the chassis and the respective ingredient chambers above a blade,
manipulating the position of an ingredient chamber to control whether the ingredients within the chamber will make contact with the blade.
